(19) United States
(12) Patent Application Publication
(10) Pub. No.: US 2011/0014591 A1
(43) Pub. Date: Jan. 20, 2011

(54) Apparatus, System, and Method for an Educational Edible Novelty Product

(76) Inventor: Rose Studstrup, Salt Lake City, UT (US)

Correspondence Address: Kunzler Needham Massey & Thorpe, 8 EAST BROADWAY, SUITE 600, SALT LAKE CITY, UT, 84111, US

(21) Appl. No.: 12/840,084

(22) Filed: Jul. 20, 2010

Related U.S. Application Data
(60) Provisional application No. 61/226,992, filed on Jul. 20, 2009.

(51) Int. Cl. G09B 21/00; G09B 19/00; G09B 25/00

(52) U.S. Cl. 434/112; 434/127; 434/365

(57) ABSTRACT

An apparatus, system, and method are disclosed for an educational edible novelty product. In some embodiments the novelty product may comprise a representation of a visually transmitted manual language element. The representation may comprise a depiction of a first human hand, which may comprise at least one finger and a first palm. The at least one finger may be articulated to communicate a manual language element.

### CROSS-REFERENCES TO RELATED APPLICATIONS

This application claims priority to United States Provisional Application No. 61/226,992 entitled “Apparatus, System, and Method for an Educational Edible Novelty Product” and filed on Jul. 20, 2009 for Rose Studstrup, which is incorporated herein by reference for all that it contains.

### BACKGROUND

This disclosure relates to a novelty and more particularly relates to educational edible novelty. Edible novelties may often serve a function as a treat or snack. In some embodiments, an edible novelty may also serve a function as an educational tool. A teacher may present a student with an edible novelty as an award for completing a task or learning an objective.

### SUMMARY

The present subject matter has been developed in response to the present state of the art. Accordingly, embodiments of the present subject matter have been developed to provide an apparatus, system, and method for an educational edible novelty product.

In some embodiments the novelty product may comprise a representation of a visually transmitted manual language element. The representation may comprise a depiction of a first human hand, which may comprise at least one finger and a first palm. The at least one finger may be articulated to communicate a manual language element. The representation of the manual language element may be disposed within a packaging that displays a letter, a word, or a phrase that corresponds to a translation of the manual language element that is disposed therein.

In further embodiments, the edible novelty product may comprise a candy material and the representation may comprise an embossment. The representation may be of a plurality of language elements such that the elements form a phrase, a collection of letters, or a collection of letters that forms at least one word.

The representation may also comprise one or more of a depiction of a second hand, a depiction of an arm, a depiction of a face, or a depiction of a head. The first human hand may comprise a first thumb finger, a first index finger, a first middle finger, a first ring finger, and a first pinky finger. A second hand may also comprise a second palm, a second thumb finger, a second index finger, a second middle finger, a second ring finger, and a second pinky finger. At least one finger may be articulated to form an American Sign Language gesture.

A variety of different visually transmitted manual language elements may be represented by articulating the fingers, palms, and hands to depict different language elements. In some embodiments the first middle finger and the first ring finger may curled toward the first palm of the first hand with the first thumb finger, the first index finger, and the first pinky finger extended outward, away from the first palm, such that the depiction communicates “I love you” in American Sign Language. In other embodiments, the first ring finger and the first pinky finger may be curled toward the first palm of the first hand and held in place by the first thumb finger, and the first index finger and first middle finger may extend upward such that the depiction communicates “Peace.” In further embodiments, the first index finger, the first middle finger, and the first ring finger may be curled down toward the first palm of the first hand with the first thumb finger and the first pinky finger extended out in opposite directions, such that the depiction communicates “Hang Loose.” In an additional embodiment, the first middle finger, the first ring finger, and the first thumb finger may be curled toward the first palm of the first hand, and the first pinky finger and the first index finger may be extended such that the depiction communicates “Rock On”. In another embodiment the first index finger, the first middle finger, the first ring finger, the first pinky finger, and the first thumb finger may be positioned such that the depiction communicates a letter from the American Sign Language alphabet. In one embodiment, the first index finger, the first middle finger, the first ring finger, the first pinky finger, and the first thumb finger of the first hand may all extend to a single point in front of the first palm of the first hand. The second index finger, the second middle finger, the second ring finger, the second pinky finger, and the second thumb finger of the second hand may all extend to a single point in front of the second palm of the second hand. The first palm of the first hand may face the second palm of the second hand, while the first index finger, the first middle finger, the first ring finger, the first pinky finger, and the first thumb finger of the first hand touch the second index finger, the second middle finger, the second ring finger, the second pinky finger, and the second thumb finger of the second hand such that the depiction communicates “Kiss” in American Sign Language.

A method is also claimed for teaching a visually transmitted language. The method comprises the step of providing an edible three-dimensional representation of a manual language element. A teacher then allows a student to identify the manual language element. The teacher then verifies that the student correctly identified the manual language element. The teacher then gives the student the edible three-dimensional representation of the manual language element as a prize for correctly identifying the element. In some embodiments, the representation may comprise a depiction of a human hand, wherein the human hand comprises at least one finger and a palm, the at least one finger may be articulated to communicate the manual language element.

### BRIEF DESCRIPTION OF THE DRAWINGS

In order that the advantages of the subject matter will be readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1 is an illustrative perspective view of an edible teaching product that includes opaque packaging in accordance with one exemplary embodiment;

FIG. 2 is an illustrative perspective view of an edible teaching product that includes clear packaging in accordance with one exemplary embodiment;

FIG. 3 is an illustrative front view of an exemplary embodiment of the edible teaching product having a plurality of hands that when viewed together create a meaning;

FIGS. 4A and 4B are illustrative views showing the front and back of an exemplary embodiment of the edible teaching product having a human hand formed into a common gesture;

FIGS. 5A and 5B are illustrative views showing the front and back of an exemplary embodiment of the edible teaching product having a human hand formed into a common gesture;

FIGS. 6A and 6B are illustrative views showing the front and back of an exemplary embodiment of the edible teaching product having a human hand formed into a common gesture;

FIGS. 7A and 7B are illustrative views showing the front and back of an exemplary embodiment of the edible teaching product having a human hand formed into a common gesture;

FIGS. 8A and 8B are illustrative views showing the front and back of an exemplary embodiment of the edible teaching product having a human hand formed into a phrase in American Sign Language;

FIGS. 8C and 8D are illustrative views showing the side and top views of an exemplary embodiment of the edible teaching product having a human hand formed into a phrase in American Sign Language;

FIG. 9 is an illustrative perspective view showing an exemplary embodiment of the edible teaching product having a human hand mounted on an edible stabilizing disk.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the subject matter may be combined in any suitable manner in one or more embodiments. In the following description, numerous specific details are provided to provide a thorough understanding of embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the subject matter.

For the purposes of the present description and the appended claims, the term “language element” is used to refer to any type of communication that is physically represented in three dimensions. The term is meant to refer broadly to all types of physically represented communicative elements whether such elements are represented as single letters, as written words, or as phrases on some medium. Likewise, words or phrases that are sculpted out of some medium so as to be pictorial or iconographical in their representation would also fall within the meanings of the term “language element”.

Furthermore, for the purposes of the present description and appended claims, the term “packaging”, whether clear or opaque, is used to refer to any kind of packaging that is appropriate for edible products. This term can include, but is not limited to, cellophane, cardboard, plastic, aluminum foil, paper, fabric and the like.

Additionally, for the purposes of the present description and appended claims, the term “edible” is used to refer to a product that is fit for human consumption. In certain embodiments the term “edible” may also include a food product that is pleasant to eat.

Also, for the purpose of the present description and the appended claims, the term “articulated” is used to refer a finger or a palm or a portion of a hand comprising a posed position. In some embodiment, the present subject matter may comprise a depiction of a human hand. While an actual human hand comprises articulation in the form of joints, the depiction of the human hand may be articulated such that the depiction of the human hand comprises a posed position.

Manual communication systems use articulation of the human hand to communicate messages between at least two individuals. The term “manual communication” includes any communication using the human hand, including static gestures as well as more complex gestures involving movement of the hand or other parts of the human body. Manual communication is typically done visually with a receiving party viewing, identifying and interpreting the manual gestures of the broadcasting party. Manual communication can be used between individuals wishing or needing to communicate thoughts or ideas without using verbal or audible communications. For example, scuba divers may find verbal or audible communication between one another difficult or impossible due to the limited conductivity of sound waves through a liquid. Therefore, scuba divers have created a system of hand signals that include codes for verbal communication.

Similar systems have been developed for use when verbal or audible communication, while possible, is inadvisable. For example, in baseball base coaches have developed hand signals to communicate instructions to players on base. These hand signals may be unique to a particular team such that an opponent is unable to identify or decipher the communication between base coach and runner. Another example of nonverbal, nonaudible manual communication is hand signals developed by the military to allow soldiers to communicate silently.

Manual communication systems have also been developed to allow individuals who cannot hear or individuals who cannot speak to communicate with others. For example, in the early 17^{th} century a method of oral education for deaf or hard of hearing individuals was developed which used manual signs for the alphabet. This system has evolved into the present day sign languages such as the American Sign Language, Dutch Sign Language, German Sign Language, Flemish Sign Language, Belgian Sign Language, Irish Sign Language, Quebec Sign language, etc.

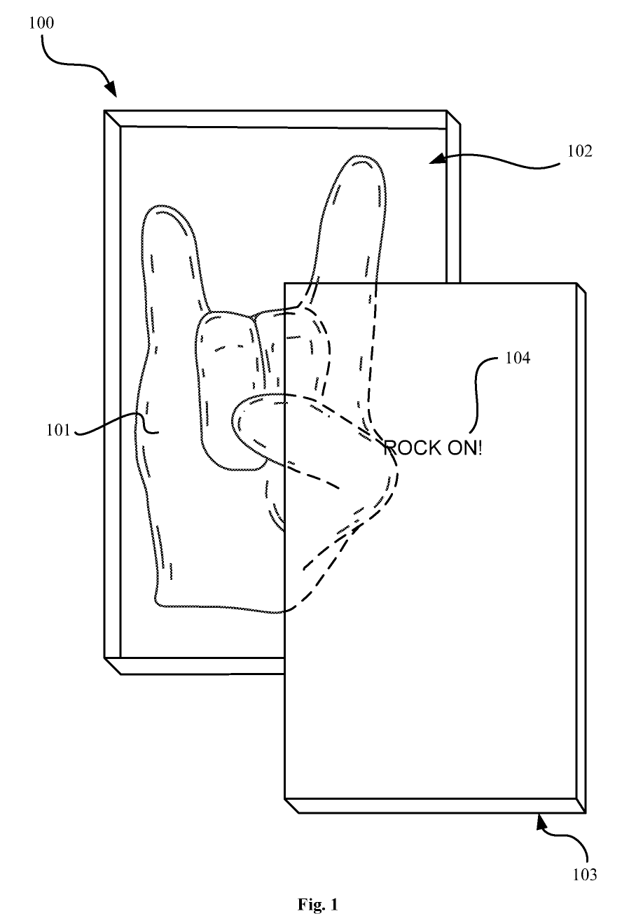

Sign language systems may include individual hand gestures for each letter in an alphabet. Additionally, sign language systems may also include hand gestures for words or phrases. Sign gestures are often arbitrary and do not necessarily have a visual relationship to the corresponding letter, word or phrase. Thus, sign languages can be as difficult to learn and become fluent in as any language. Accordingly, any system, method or apparatus that provides an incentive to learn a manual communication system would be an improvement in the art. FIGS. 1-9 are directed to such a system, method and apparatus.

FIG. 1 depicts one embodiment of an edible teaching product 100, utilizing both the edible product 101 as well as its packaging. While the embodiment illustrated in FIG. 1 includes both the edible product as well as the packaging, one of skill in the art will recognize that in certain embodiment the edible teaching product 100 may include the edible product 101 without the packaging. The edible product 101 is shown as a food product that has been formed into the shape of a human hand making the commonly known gesture that, when translated, means “Rock On!” In the depicted product, the edible product 101 is placed into the bottom portion 102 of the opaque packaging in the shape of a box. When the top portion 103 of the opaque packaging is in place, the edible product may be totally obscured. Featured on the top portion 103 of the opaque packaging is a letter, letter, word or phrase 104 that, when translated, is the same letter, letter, word or phrase that is depicted by the inner edible product 101.

While the embodiment illustrated in FIG. 1 depicts the top portion 103 of the packaging as an opaque material, one of skill in the art will recognize that in certain embodiments the top portion 103 of the packaging may be made of a transparent or semitransparent material. Thus, in certain embodiments the edible product 101 may be seen through the top portion 103 of the packaging. In another embodiment the packaging may only include the bottom portion 102 with the edible product 101 attached to the bottom portion 102. In such an embodiment, the bottom portion 102 may include the letter, letter, word or phrase 104 corresponding to the letter, letter, word or phrase depicted by the edible product 101. One of skill in the art will recognize that in certain embodiments the packaging may omit the letter, letter, word or phrase 104.

As depicted in FIG. 1, the edible teaching product 100 can be used as a game or teaching device, where a person reads the letter, word or phrase 104 on the top portion 103 of the opaque packaging and has to make the correct corresponding hand gesture before accessing the edible product 101 contained within the bottom portion 102 of the packaging. When the edible product 101 is made out of a sweet material, like chocolate or other candy, this creates effective motivation for the game participant to remember the correct hand gestures. Furthermore, having the edible product 101 formed in the shape of the correct hand gesture ensures that the game participant practices correct finger placement for that gesture.

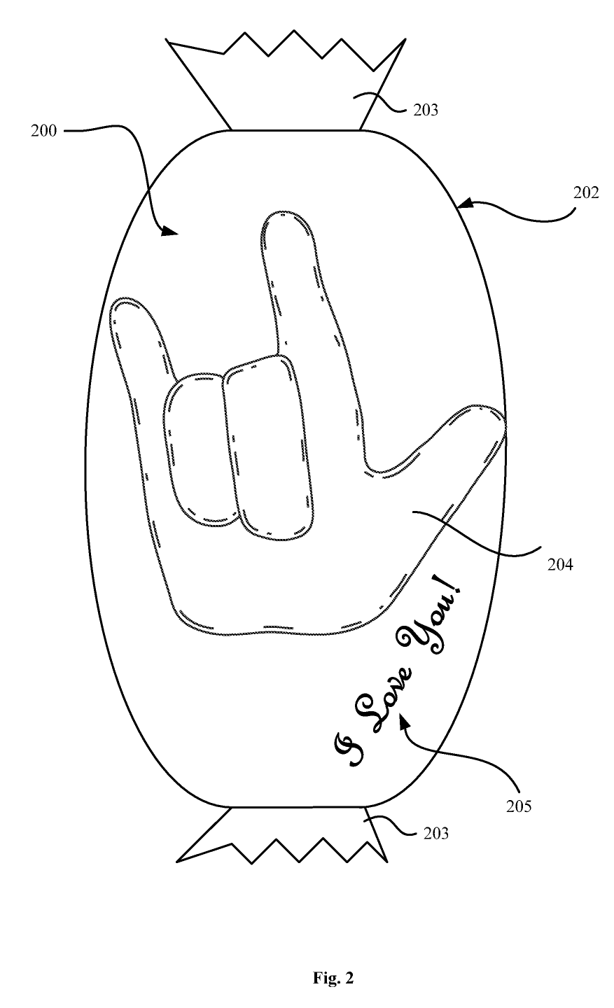

FIG. 2 depicts an embodiment of an edible teaching product 200, utilizing both the edible product 204 as well as its packaging. The edible product 204 is shown as a food product that has been formed into the shape of a human hand making a sign in American Sign Language that corresponds to the phrase “I Love You.” In the depicted product 200, the edible product 204 is wrapped in a transparent or semitransparent packaging material 202 that has been twisted at both ends 203 and tied. In one embodiment a letter, word or phrase 205 is printed onto the surface of the transparent or semitransparent packaging material 202. The printed letter, word or phrase 205 corresponds to the letter, word or phrase depicted by the edible product 204.

As depicted in FIG. 2, the edible teaching product 200 can be used as a silent communication device. For example, the edible teaching product 200 can convey a message at a time when verbal or audible communication is not appropriate such as in church or school setting. Additionally, in certain embodiments, as depicted in FIG. 2, the edible teaching product 200 may be used as a gift or presentation to familiarize people who are not fluent in Sign Language to certain letters, words, or phrases from the Sign Language. In one embodiment mimicking the hand positioning as shown by the edible product 204 and then reading the translation of the letter, word, or phrase on the packaging material 202 helps an individual unfamiliar with Sign Language to remember hand signs and their translations.

While the embodiments illustrated in FIGS. 1-9 depict hand gestures used in the American Sign Language, one of skill in the art will recognize that the present subject matter may be practiced using two or three dimensional hands depicting gestures corresponding to any letter, word or phrase from any language. Thus, hand gestures from any sign language, such as Dutch Sign Language, German Sign Language, Flemish Sign Language, Belgian Sign Language, Irish Sign Language, Quebec Sign language, etc., may be used with the present subject matter.

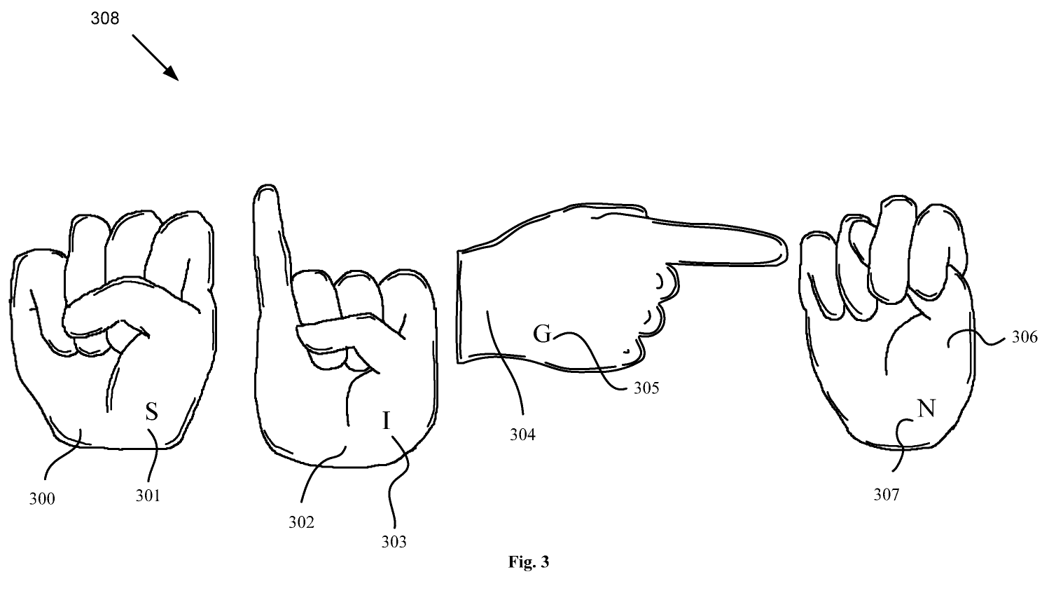

FIG. 3 depicts an embodiment of system 308 for communicating a message using edible teaching products where the edible product are shaped into the form of a human hand making a sign in American Sign Language that represents a certain letter of the alphabet. In one embodiment, the system 308 includes a plurality of edible products, such as edible products 300, 302, 304, and 307. Each edible product 300, 302, 304, and 307 may correspond to a letter, word or phrase which may be arranged to communicate a message. For example, as further described below, in the system 308 illustrated in FIG. 3, the edible products 300, 302, 304, and 307 correspond to the letters ‘S’, ‘I’, ‘G’, and ‘N’ respectively. Thus, the system 308 communicates the word “SIGN” to individuals viewing system 308. In other embodiments other words or phrases may be communicated by system 308.

When the fist of the hand is closed with the thumb placed around the closed fingers, the resulting gesture is equivalent to the letter ‘S’ in American Sign Language. In FIG. 3, the edible product 300 is thus shaped so as to indicate the represented letter ‘S’. In certain embodiments the edible product 300 may also be marked with the corresponding letter. Thus, in the embodiment illustrated in FIG. 3, the edible product 300 depicting the letter ‘S’ is also marked with the letter ‘S’ 301. In this manner, an individual unfamiliar with Sign Language is still able to identify the hand gesture that makes up the ‘S’ of edible product 300. In other embodiments the stamped letter ‘S’ 301 may be omitted such that the hand gesture is the only indication of the represented letter, word or phrase.

Next in FIG. 3 is edible product 302 that is shaped into a human hand with the index, middle, and ring fingers of the hand closed with the thumb encircling them and the pinky finger extended straight. When a hand is thus positioned, the resulting gesture is equivalent to the letter ‘I’ in American Sign Language. Again, the edible product 302 is stamped with the letter ‘I’ 303 to indicate the represented letter. In other embodiments the stamped letter ‘I’ 303 may be omitted such that the hand gesture is the only indication of the represented letter, word or phrase.

Moving on in FIG. 3, there is edible product 304 that is shaped into a human hand facing sideways with the middle, ring, and pinky fingers curled into the palm with the index and thumb fingers held straight and parallel with both fingers pointing in the same direction. When the human hand is thus configured, the resulting gesture is equivalent to the letter ‘G’ in American Sign Language. As with the other members of this embodiment, the edible product 304 is stamped with the letter ‘G’ so as to indicate the represented letter. In other embodiments the stamped letter ‘G’ 305 may be omitted such that the hand gesture is the only indication of the represented letter, word or phrase.

Finally in FIG. 3, there is depicted edible product 307 that is shaped into a human hand with the index, middle, ring, and pinky fingers curled into the palm of the hand with the thumb finger inserted under the index and middle fingers and extended above the ring finger. When a hand is thus shaped, the resulting gesture is equivalent to the letter ‘N’ in American Sign Language. As with the above members, the edible product 307 is marked with the letter ‘N’ 307 so as to indicate the represented letter. In other embodiments the stamped letter ‘N’ 303 may be omitted such that the hand gesture is the only indication of the represented letter, word or phrase.

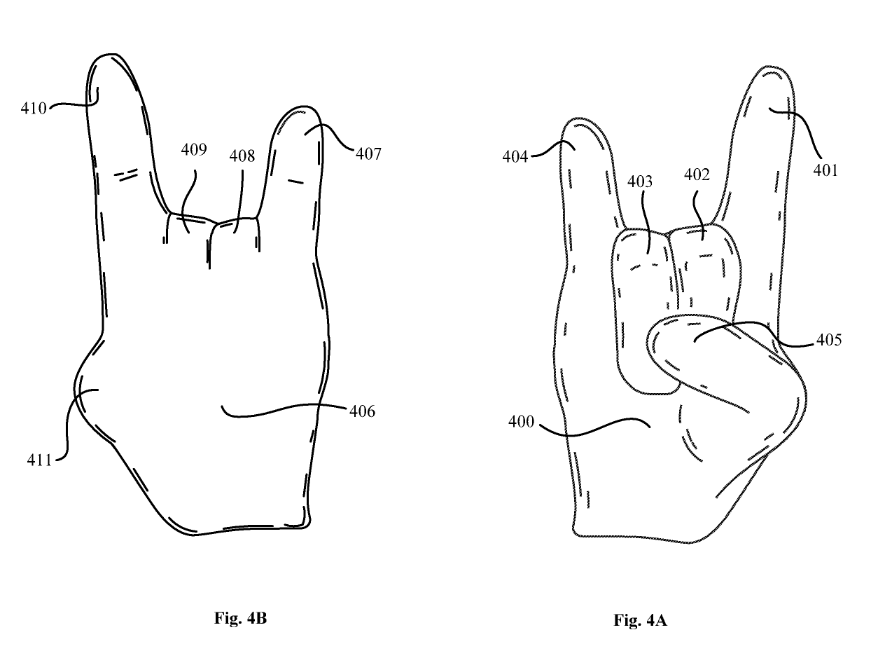

When embodied as depicted in FIG. 3, the present subject matter can make for a fun and effective spelling game for children, or as a helpful way for sign language learners to remember and correctly form the gestures that represent letters. When used as a children's game, the members of FIG. 3 can be placed on a flat surface in front of the child. When the child correctly identifies the word as “SIGN”, the child gets to eat one of the edible products 302, for example the letter ‘I’, which can then be replaced with another edible product that perhaps represents the letter ‘A’. The remaining edible products 300, 304, and 307, along with the replacement edible product that represents the letter ‘A’ may be arranged to depict the word “SANG.” When the child correctly identifies the new letter arrangement as “SANG”, he gets to eat another edible product, and so on. When used as a teaching aid to help sign language learners, the edible products 300, 302, 304, and 307 of FIG. 3 effectively demonstrate the correct finger placement for different letters of the alphabet. In certain embodiments the edible products 300, 302, 304, and 307 also provide a quick reference to the actual letter that the sign represents. FIG. 4 represents an edible teaching product in the three dimensional shape of a human hand from both a front view, FIG. 4A, and a rear view, FIG. 4B. In FIG. 4A, the middle finger 402 and the ring finger 403 are curled down into the palm of the hand 400 and held in place by the thumb 405, with the index finger 401 and pinky finger 404 are extended upward. This common gesture is one that has come to mean “Rock On!” In FIG. 4B, the same gesture is shown from a rear view. The middle finger 409, ring finger 408, and thumb finger 411 are curled away from the back of the hand 406 with the index finger 410 and pinky finger 407 extended upward. An edible teaching product in this formation may be useful as a means of silent communication, a gift, or a reward.

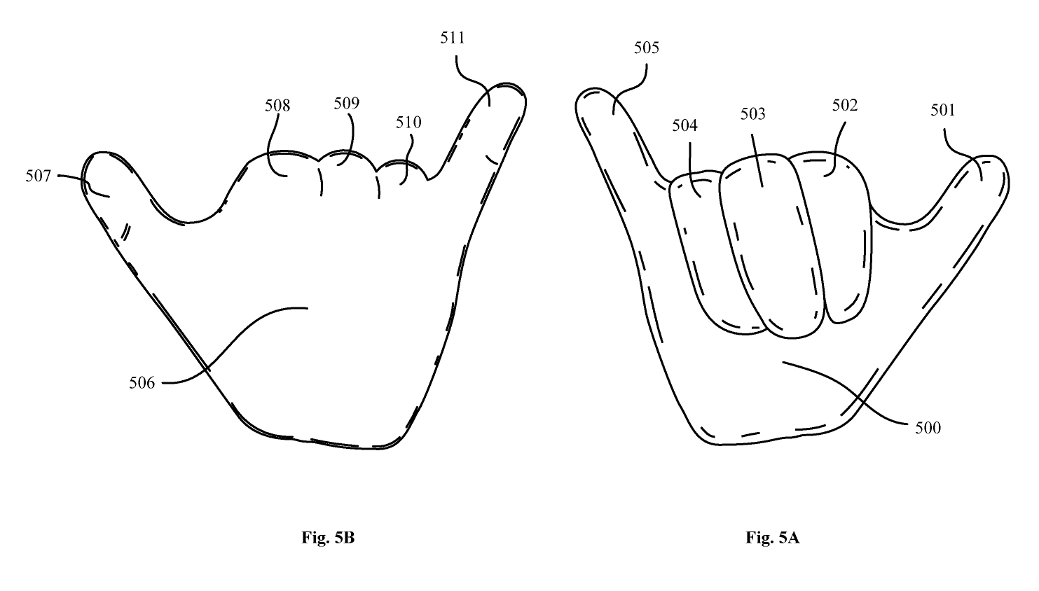

FIG. 5 represents an edible teaching product in the three dimensional shape of a human hand from both a front view, FIG. 5A, and a rear view, FIG. 5B. In FIG. 5A, the index finger 502, the middle finger 503, and the ring finger 504 are curled down toward the palm of the hand 500 with the thumb finger 501 and pinky finger 505 extended out in opposite directions. This gesture is one that is commonly known to mean “Hang Loose.”

In FIG. 5B, the same gesture is shown from a rear view. The index finger 508, middle finger 509, and ring finger 510 are curled away from the back of the hand 506 with the pinky finger 511 and thumb finger 507 extended out in opposite directions. As with FIG. 4, and edible teaching product in the formation depicted in FIG. 5 may be useful as a means of silent communication, a gift, or a reward.

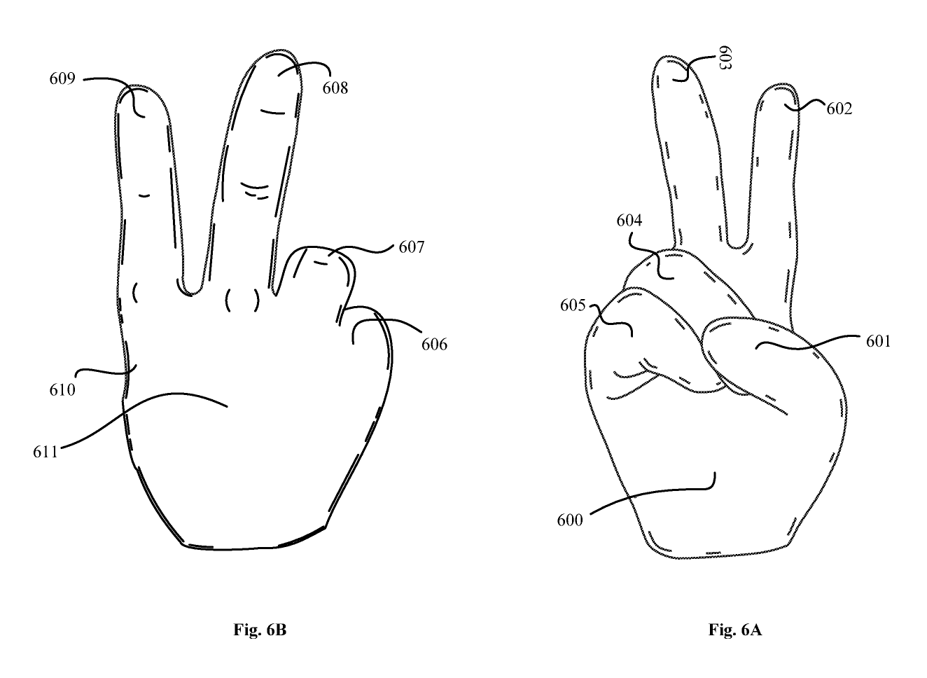

FIG. 6A and 6B represents an edible teaching product in a three dimensional shape of a human hand. FIG. 6A illustrates a front view of the edible teaching product and FIG. 6B illustrates a rear view of the edible teaching product.

In FIG. 6A, the ring finger 604 and pinky finger 605 are curled toward the palm of the hand 600 and are held in place by the thumb 601. The index finger 602 and middle finger 603 are extended upward. One of skill in the art will recognize that this gesture is one that commonly means “Peace.” In FIG. 6B, the same gesture is shown from a rear view. The ring finger 607, thumb finger 610, and pinky finger 606 are curled away from the back of the hand 611 with the index finger 609 and middle finger 608 extended upward. An edible teaching product in this formation may be useful as a means of silent communication, a gift, or a reward.

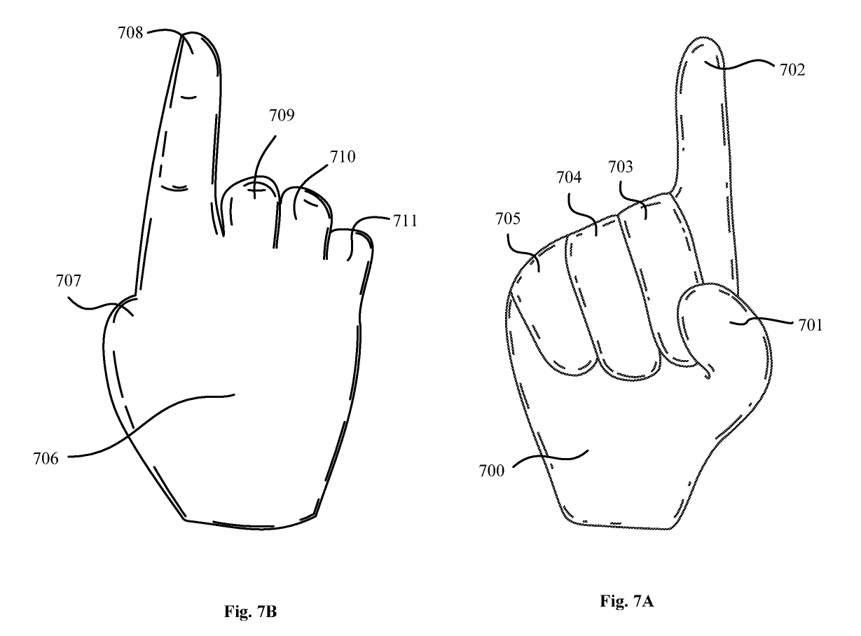

FIG. 7A and FIG. 7B represent a front and rear view respectively of an edible teaching product in the three dimensional shape of a human hand. In FIG. 7A, the middle finger 703, ring finger 704, and pinky finger 705 are curled toward the palm of the hand 700 and are held in place by the thumb finger 701 with the index finger 702 extended upward. One of skill in the art will recognize that this gesture is one that commonly means “Number One!”

In FIG. 7B, the “Number One!” gesture of FIG. 7A is shown from a rear view. The middle finger 709, ring finger 710, pinky finger 711, and thumb finger 707 are curled away from the back of the hand 706 with the index finger 708 extended. An edible teaching product in this formation may be appropriate as a gift for a winning team, as a means of silent communication, or as a reward.

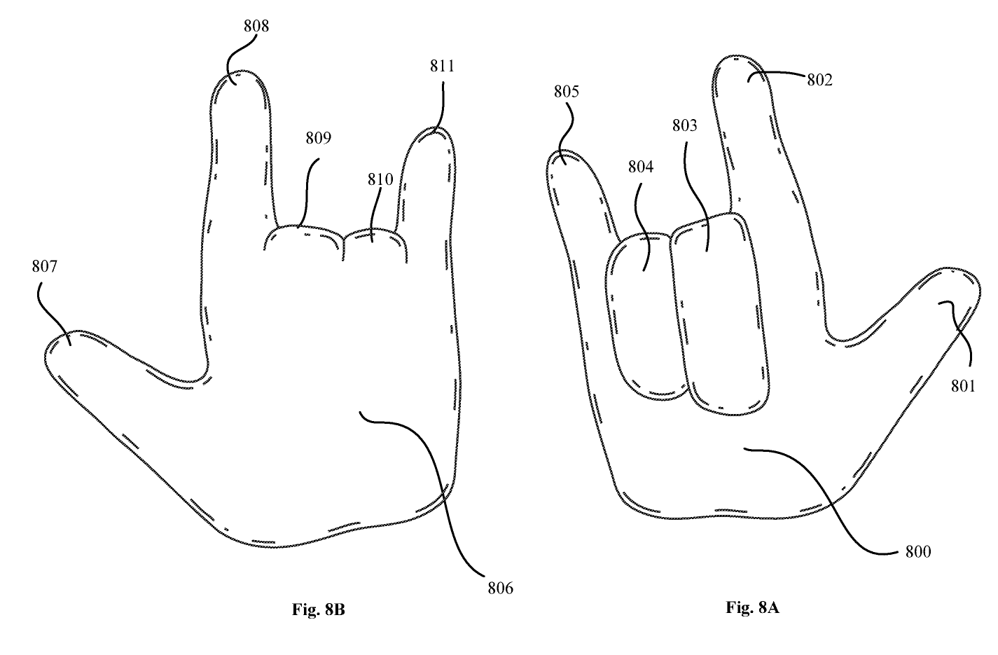

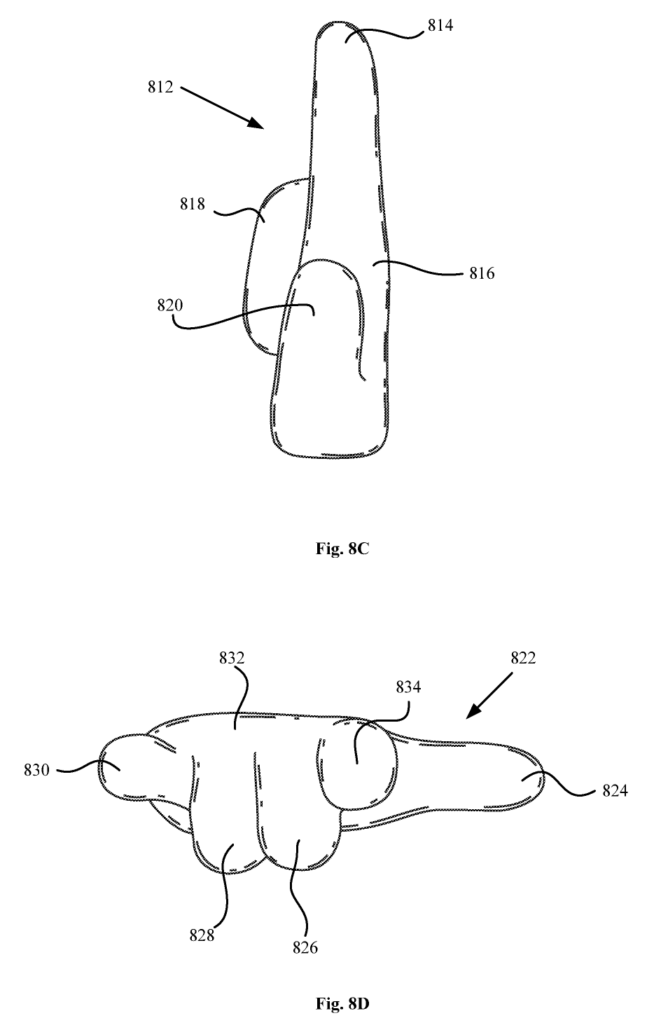

FIG. 8A and FIG. 8B represent a front and rear views respectively of an edible teaching product in the three dimensional shape of a human hand. In FIG. 8A, the middle finger 803 and ring finger 804 are curled toward the palm of the hand 800 with the thumb finger 801, the index finger 802, and the pinky finger 805 extended outward, away from the palm 800. In American Sign Language, this hand gesture translates to the phrase “I Love You.” In FIG. 8B, the “I Love You” gesture of FIG. 8A is shown from a rear view. The middle finger 809 and ring finger 810 are curled away from the back of the hand 806 with the thumb finger 807, the index finger 808, and the pinky finger 811 extended outward, away from the back of the hand 806. An edible teaching product in this formation may be given as a gift, as a reward, as a means of teaching a phrase in American Sign Language, or as a means of silent communication.

FIG. 8C and 8D represent the side and top views respectively of an edible teaching product in the three dimensional shape of a human hand. In FIG. 8C, the hand 812 is shown with the thumb 829 extended away from the palm and the other fingers, with the index finger 814 held vertically, in line with the back of the hand 816 away from the palm, and the middle finger 818 curled into the palm. The ring finger and pinky finger are not visible in this view. In FIG. 8D, the hand 822 is shown with the thumb 824 extended away from the palm and the other fingers, with the index finger 834 and pinky finger 830 held vertically, in line with the back of the hand 832, and the middle 826 and ring fingers 828 curled into the palm of the hand. An edible teaching product in this formation may be given as a gift, as a reward, as a means of teaching a phrase in American Sign Language, or as a means of silent communication.

While the embodiments illustrated in FIGS. 1-9 include gestures performed by a single hand, one of skill in the art will recognize that in certain embodiments two hand gestures may be included. For example, one of skill in the art will recognize that in certain sign languages the gesture for the term “Kiss” includes both hands having the fingers touching their thumbs where both hands are brought together.

Similarly, in one embodiment additional appendages or body parts may be included in the edible teaching product. For example, in one embodiment a representation of a human head or other body part may be included in the edible teaching product. One of skill in the art will recognize that in certain sign languages the gesture for the term “Eat” includes the right hand near the mouth. Thus, the edible teaching product may include a simulated human head to accommodate such a simulation.

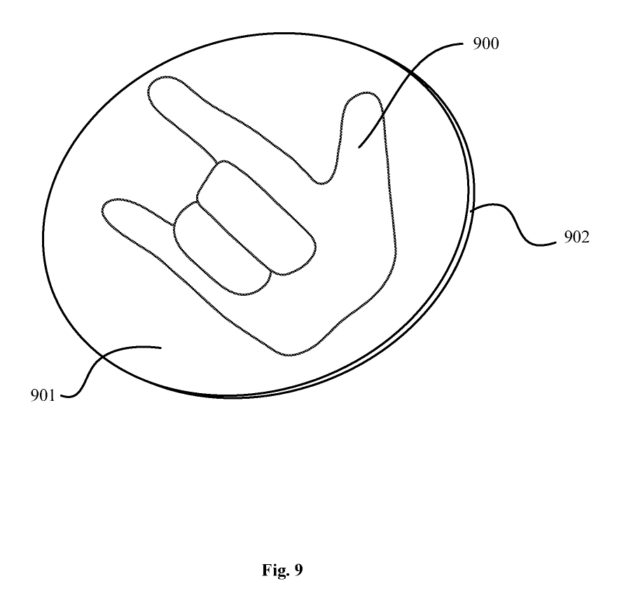

FIG. 9 represents an embodiment of the present subject matter where the edible teaching product 900 is mounted onto a disk 901. In certain embodiments the disk 901 is created from edible material that is the same as the edible material that comprises the edible teaching product 900. In another embodiment the edible teaching product 900 and the disk 901 are made of dissimilar edible materials. In one embodiment the edible material comprising the edible teaching product 900 may include a material selected to complement the taste of the edible material comprising the disk 901.

When the edible teaching product 900 is made out of a material like chocolate, or sugar hard candy, certain aspects of that teaching product may become fragile or brittle and it becomes necessary to provide the product with some kind of stabilization. For this reason a sturdy disk 901 of some edible material that has some thickness 902 can be used as part of the mold for the teaching product 900. The efficacy of the teaching product remains virtually unchanged as all that is lost from the product is the rear view of the hand.

In other embodiments, the edible teaching product 900 may comprise an embossment on the disk 901, such that the edible teaching product 900 comprises an extension outward from the disk 901 or comprises an impression into the disk 901. In these embodiments, the edible portion of the teaching product may comprise the disk 902.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An edible novelty, comprising:
an edible three-dimensional representation of a visually transmitted manual language element, the representation comprising a depiction of a first human hand;
wherein the first human hand comprises at least one finger and a first palm, the at least one finger articulated to communicate the manual language element; and
packaging that displays one of a letter, a word, and a phrase corresponding to a translation of the edible three-dimensional representation of the visually transmitted manual language element.

2. The edible novelty from claim 1, wherein the representation comprises an embossment.

3. The edible novelty from claim 1, wherein the representation of the visually transmitted language element comprises one or more of a depiction of a second hand, a depiction of an arm, a depiction of a face, and a depiction of a head.

4. The edible novelty of claim 1, wherein the representation of the visually transmitted language element comprises a plurality of manual language elements.

5. The edible novelty of claim 4, wherein the plurality of manual language elements forms a phrase.

6. The edible novelty of claim 4, wherein the plurality of manual language elements forms a collection of letters.

7. The edible novelty of claim 6, wherein the collection of letters forms at least one word.

8. An educational confection, comprising:
an edible three-dimensional representation of a manual language element, the representation comprising a depiction of a first human hand;
wherein the first human hand comprises at least one finger and a first palm, the at least one finger is articulated to communicate the manual language element.

9. The educational confection according to claim 8, wherein the edible three-dimensional representation of the visually transmitted manual language element comprises a candy material.

10. The educational confection according to claim 8, wherein the at least one finger is articulated to form an American Sign Language gesture.

11. The educational confection according to claim 8, wherein the first human hand comprises a first thumb finger, a first index finger, a first middle finger, a first ring finger, and a first pinky finger.

12. The educational confection according to claim 11, wherein the first middle finger and the first ring finger are curled toward the first palm of the first hand with the first thumb finger, the first index finger, and the first pinky finger extended outward, away from the first palm, such that the depiction communicates “I love you” in American Sign Language.

13. The educational confection according to claim 11, wherein the first ring finger and the first pinky finger are curled toward the first palm of the first hand and are held in place by the first thumb finger, and wherein the first index finger and first middle finger are extended upward such that the depiction communicates a “Peace” sign.

14. The educational confection according to claim 11, wherein the first index finger, the first middle finger, and the first ring finger are curled down toward the first palm of the first hand with the first thumb finger and the first pinky finger extended out in opposite directions, such that the depiction communicates a “Hang Loose” sign.

15. The educational confection according to claim 11, wherein the first middle finger, the first ring finger, and the first thumb finger are curled toward the first palm of the first hand, and the first pinky finger and the first index finger are extended such that the depiction communicates a “Rock On” sign.

16. The educational confection according to claim 11, wherein the first index finger, the first middle finger, the first ring finger, the first pinky finger, and the first thumb finger are positioned such that the depiction communicates a letter from the American Sign Language alphabet.

17. The educational confection according to claim 11, wherein the representation comprises a depiction of a second human hand, the second human hand comprising a second palm, a second thumb finger, a second index finger, a second middle finger, a second ring finger, and a second pinky finger.

18. The educational confection according to claim 17, wherein the first index finger, the first middle finger, the first ring finger, the first pinky finger, and the first thumb finger of the first hand all extend to a single point in front of the first palm of the first hand; and wherein the second index finger, the second middle finger, the second ring finger, the second pinky finger, and the second thumb finger of the second hand all extend to a single point in front of the second palm of the second hand; wherein the first palm of the first hand is facing the second palm of the second hand, with the first index finger, the first middle finger, the first ring finger, the first pinky finger, and the first thumb finger of the first hand touching the second index finger, the second middle finger, the second ring finger, the second pinky finger, and the second thumb finger of the second hand such that the depiction communicates “Kiss” in American Sign Language.

19. A method for teaching a visually transmitted language, the method comprising:
providing an edible three-dimensional representation of a manual language element, the representation comprising a depiction of a first human hand;
wherein the three-dimensional representation of a manual language element comprises at least one finger and a first palm, the at least one finger articulated to communicate the manual language element;
allowing a student to identify the manual language element; and
verifying the student correctly identified the manual language element.

20. The method of claim 19, further comprising giving the student the edible three-dimensional representation of the manual language element as a prize for correctly identifying the element.
